(19) United States
(12) Patent Application Publication
(10) Pub. No.: US 2018/0269602 A1
(43) Pub. Date: Sep. 20, 2018

(54) ELECTRICAL POWER ACCESSORY

(71) Applicant: OTTOCAM (PTY) LTD, KEMPTON PARK (ZA)

(72) Inventor: David OTTO, Kempton Park (ZA)

(21) Appl. No.: 15/758,317

(22) PCT Filed: Sep. 9, 2016
(86) PCT No.: PCT/IB2016/055374

§ 371 Date: Mar. 7, 2018

(30) Foreign Application Priority Data
Sep. 10, 2015 (ZA) 2015/06690

(51) Int. Cl. H01R 4/48; H01R 9/24; H01R 13/70; H01R 24/30; H01R 4/50

(52) U.S. Cl. CPC H01R 4/4845; H01R 9/2491; H01R 4/50; H01R 24/30; H01R 13/70

(57) ABSTRACT

This invention relates to an electrical power accessory which includes a device housing and a wire connection receptacle integrated into the device housing, the wire connection receptacle having two or more wire receiving formations selected from any two or more of an earth wire receiving formation, a neutral wire receiving formation and a live wire receiving formation, each wire receiving formation having a wire retainer for securing a wire in the receptacle, each wire receiving formation being marked according to the type of wire receivable therein. The electrical power accessory also includes an electrical contact in each wire receiving formation, each electrical contact being connected to an electrical conductor extending from the wire connection receptacle such that when a wire is received within the wire receiving formation, the wire is electrically connected to the electrical conductor.

### FIELD OF THE INVENTION

This invention relates to an electrical power accessory. In particular the invention relates to an electrical power accessory and an electrical replacement plug.

### BACKGROUND OF THE INVENTION

Electrical power accessories such as electrical plugs, extension cable sockets, wall mounted power socket outlets, wall mounted switches, inline switches and the like require electrical wiring to function.

Although such wiring is effortlessly performed by a suitably qualified electrician, it can be a daunting task for an unskilled person. Incorrect wiring could result in mild to severe electrocution and can also lead to damage to appliances. Many people are not aware of the potential risks and do not have sufficient electrical knowledge to safely wire such accessories.

The inventor is aware of the hassle and danger involved in wiring certain electrical power accessories and identified a need to simplify connecting bared wires to electrical power accessories.

This invention aims to achieve this.

### SUMMARY OF THE INVENTION

According to a first aspect of the invention there is provided an electrical power accessory, which includes
a device housing;
a wire connection receptacle integrated into the device housing, the wire connection receptacle having two or more wire receiving formations selected from any two or more of an earth wire receiving formation, a neutral wire receiving formation and a live wire receiving formation, each wire receiving formation having a wire retainer for securing a wire in the receptacle, each wire receiving formation being marked according to the type of wire receivable therein; and
an electrical contact in each wire receiving formation, each electrical contact being connected to an electrical conductor extending from the wire connection receptacle such that when a wire is received within the wire receiving formation, the wire is electrically connected to the electrical conductor.

The electrical power accessory may be selected from any one of: an electrical plug, an extension cable socket, wall mounted power socket outlet, wall mounted switches, inline switches and the like.

The wire connection receptacle may be accessible from the outside of the device housing.

The wire receiving formations may be in the form of channels having entrance ports, in use through which a wire is receivable. Each channel may be electrically isolated from the other channels. Each channel being shaped and dimensioned to receive only one bared wire form an electrical cable.

The wire retainers may be displaceable between an open position, in which a wire is receivable into the wire receiving formation and a closed condition, in which the wire is retained in the wire receiving formation. In an open condition the channels are open and a wire is receivable therein, and in a closed position the wire retainer may cause at least a portion of the channel through which a wire is received, to become constricted, in use securing the wire within the wire connection receptacle.

The wire retainers may be in the form of levers. The levers may be in the form of cam levers, in the shape of oblong lobes.

Each wire receiving formation may include a wire confinement in which a wire is clamped when the wire retainer is in a closed position.

The wire confinement may be in the form of a cage spring, the cage spring being in the form of a looped elongate member, a portion of the elongate member defining a framed aperture, in line with the channel, such that a wire is receivable there-through.

The wire receiving formations being marked, comprises indicators associated with the wire receiving formations.

The indicators may be in the form of coloured indicators. The coloured indicators may be green and yellow for the earth wire receiving formation, brown for the live wire receiving formation, and blue for the neutral wire receiving formation.

The indicators may be in the form of any one or more of: symbols, wording, abbreviations, codes or the like.

The indicators may be provided on the device housing proximate each receiving formation. Alternatively the indicators may be provided on the wire retainers. In a preferred embodiment the levers may be coloured according to the type of wire receivable in the wire receiving formation.

The conductive contact may be in the form of a current bar.

The conductive contact may be located inside the wire receiving formation, such that a bared wire makes contact with the conductive contact when a bared wire is received in a wire receiving formation.

The device housing may be moulded around a portion of the wire connection receptacle, such that the wire retainers are accessible from the outside of the housing. The device housing may be injection moulded. The device housing may be of unitary construction, advantageously preventing the device from being opened.

The current bar may be positioned through the framed aperture of the cage spring. The cage spring may be biased upwardly, thereby the lower portion of the frame is pulled upwardly onto the current bar.

The cam levers may be movable between an open condition and closed condition, in an open condition the lever engages the cage spring, such as to align the framed aperture with the channel. In an open condition, an upper portion of the lever stands proud of the device housing, and a lower portion of the lever pushes onto the cage spring, such that the framed aperture is pushed to a position below the current bar, in line with the channel, such that a bared wire is receivable through the channel and framed aperture. In an open condition the lever is substantially perpendicular to the device housing.

In a closed condition the lever does not engage the cage spring, such that the framed aperture returns to an offset position in relation to the channel, in a closed condition the cam lever is received on the plug housing, and does not push onto the cage spring, in use, when a bared wire is received in the receiving formation, and the lever is moved to a closed condition, the bared wire is clamped between the current bar and the frame. In a closed condition the lever is substantially coplanar to the device housing.

The electrical power accessory may include a strain relief clamp, for clamping a cable of which the wires are received in the wire connection receptacle.

In a specific example the electrical power accessory may be in the form of an electrical plug and the device housing is in the form of a plug housing.

The electrical conductors extending from the plug housing may be in the form of male projections extending from the base of the plug housing, each electrical contact in the wire receiving formations are electrically connected to one of the male projections.

The male projections may be in the form of any of: prongs, blades and pins.

The wire connection receptacle may be distant from the male projections. The wire connection receptacle may be located at a rear of the plug housing.

The wire receiving formations may be in the form of channels having entrance ports, in use through which a wire is receivable, the entrance ports being located at a rear of the plug housing.

The electrical connection between the male projections and the respective conductive contacts, may be in the form of a metal connection member, one end welded to the male projection and the opposed end welded to the conductive contact.

The plug housing may be moulded around a portion of the male projections and wire connection receptacle, such that the male projections extend through the plug housing and the wire retainers are accessible from the outside of the housing.

The electrical plug may further include an on/off switch, connected in circuit between either the live connection or neutral and live connection, the on/off switch operable to switch the electrical plug off/on without having to switch the wall outlet on/off.

The electrical plug may further include an on/off indicator, in the form of an indication light, operable to indicate whether the electrical plug is off or on.

The electrical plug further may include a fuse, connected in circuit between either of the live connection or neutral and live connection, the fuse being operable to break the electric current through the electrical plug when the current exceeds a safe, predetermined level.

The electrical plug may include a strain relief clamp, for clamping a cable connected to the electrical plug, the strain relief clamp being located at a rear of the plug, in front of the wire receiving formations.

According to a further aspect of the invention there is provided an electrical plug, which includes
a plug housing;
two or more male projections extending from a base of the plug housing; and
a wire connection receptacle integrated into the plug housing, accessible from the outside of the housing, the wire connection receptacle having two or more wire receiving formations, each wire receiving formation electrically connected to one of the male projections, such that when a wire is received within the wire receiving formation, the wire is electrically connected to the male projection.

The two or more male projections may be in the form of any of prongs, blades, pins or the like.

The wire connection receptacle may be distant from the two or more male projections. In one embodiment the wire connection receptacle is located at a rear of the plug housing.

The wire receiving formations may be in the form of channels having entrance ports, in use through which a wire is receivable. In one embodiment the entrance ports may be located at a rear of the plug housing.

Each channel may be electrically isolated from the other channels, advantageously preventing a wire received in one wire receiving formation from coming into contact with wires received in the other wire receiving formations. Each channel may be shaped and dimensioned to receive only one bared wire from an electrical cable. Typically, the cable will contain two or three wires running through a cable sleeve, and each of these wires are thus receivable in a separate isolated channel.

The wire connection receptacle may include wire retainers associated with the one or more wire receiving formations. The wire retainers are displaceable between an open position, in which a wire is receivable into the wire receiving formation and a closed condition, in which the wire is retained in the wire receiving formation.

In particular, in an open condition the channels may be open and a wire is receivable therein, and in a closed position the wire retainer may cause at least a portion of the channel through which a wire is received, to become constricted, in use clamping the wire within the wire connection receptacle.

In one embodiment the wire retainers may be in the form of levers. Specifically the levers may be in the form of cam levers. The cam levers may be in the shape of oblong lobes.

Each wire receiving formation further includes a wire confinement, in which a wire is clamped when the wire retainer is in a closed position.

Each wire receiving formation may further include a cage spring. The cage spring may be in the form of a looped elongate member. A portion of the elongate member defining a framed aperture, in line with the channel, such that a wire is received there-through.

Each wire receiving formation may be provided with a conductive contact. Each conductive contact may be electrically connected to a designated male projection. The designated male projections may be in the form of any one of a neutral, live and protective earth connection.

The electrical plug may include indicators to identify the type of designated male projection to which the receiving formation is electrically connected. In one embodiment the indicators may be in the form of coloured indicators, for example a green and yellow indicator for the receiving formation connected to the earth connection projection, a brown indicator for the receiving formation connected to the live connection, and a blue indicator for the receiving formation connected to the neutral connection. In another embodiment the indicators may be in the form of symbols, wording, abbreviations, codes and the like. The indicators may be provided on the plug housing proximate each receiving formation. In another embodiment the indicators may be provided on the wire retainers.

In one embodiment the conductive contact may be in the form of a current bar. The conductive contact may be located inside the wire receiving formation, such that a bared wire makes contact with the conductive contact when a bared wire is received in a wire receiving formation.

The electrical connection between the male projections and the respective conductive contacts, may be in the form of a metal connection member, one end welded to the male projection and the opposed end welded to the conductive contact. The metal connection member may be in the form of copper wire or the like. The metal connection member, may be any one of a live connection, a neutral connection and a earth connection.

The plug housing may be moulded around a portion of the male projections and wire connection receptacle, such that the male projections extend through the plug housing and the wire retainers are accessible from the outside of the housing. In one embodiment the plug housing may be injection moulded. The plug housing may be of unitary construction, advantageously preventing the plug to be opened. The plug housing may be of any one of a synthetic material, plastic, polymeric material or the like.

Specifically the current bar may be positioned through the framed aperture of the cage spring. The cage spring is biased upwardly, thereby the lower portion of the frame is pulled upwardly onto the current bar.

The cam lever may be movable between an open condition and closed condition. In an open condition the lever may engage the cage spring, such as to align the framed aperture with the channel.

In an open condition an upper portion of the lever may stand proud of the plug housing, and a lower portion of the lever pushes onto the cage spring, such that the framed aperture is pushed to a position below the current bar, in line with the channel, such that a bared wire is receivable through the channel and framed aperture. In an open condition the lever may be substantially perpendicular to the plug housing.

In a closed condition the lever does not engage the cage spring, such that the framed aperture returns to an offset position in relation to the channel. In a closed condition the cam lever is received on the plug housing, and does not push onto the cage spring. In use, when a bared wire is received in the receiving formation, and the lever is moved to a closed condition, the bared wire is clamped between the current bar and the frame. In a closed condition the lever may be coplanar to the plug housing.

In one embodiment the electrical plug may further include an on/off switch, connected in circuit between either the live connection or neutral and live connection. The on/off switch operable to switch the electrical plug off/on without having to switch the wall outlet on/off.

The electrical plug may further include an on/off indicator. The on/off indictor may be in the form of an indication light, operable to indicate whether the electrical plug is off or on. In an alternative embodiment the on/off indicator may be in the form of an indication light integrated into the on/off switch. In one embodiment the indication light may display a green colour when the plug is on, and a red colour when the plug is off.

The electrical plug may further include a fuse, connected in circuit between either of the live connection or neutral and live connection. The fuse being operable to break the electric current through the electrical plug when the current exceeds a safe, predetermined level.

The electrical plug may further include a strain relief clamp, for clamping the cable. The strain relief clamp may be located at a rear of the plug, in front of the wire receiving formations.

The invention is now described, by way of non-limiting example, with reference to the accompanying figure(s):

### FIGURE(S)

In the figure(s):

FIG. 1 shows a three-dimensional view of an electrical plug according to one embodiment of the invention, with the levers in an open condition;

FIG. 2 shows a three-dimensional view of the electrical plug of FIG. 1, with the levers in a closed condition;

FIG. 3 shows the inner wiring of the electrical plug of FIG. 1;

FIG. 4 show a top view of one embodiment of the electrical plug;

FIG. 5 shows a sectional view at V:V of FIG. 1;

FIG. 6 shows a sectional view at VI:VI of FIG. 2;

FIG. 7 shows a detailed view of a cage spring in an open condition;

FIG. 8 shows a detailed view of the cage spring of FIG. 7 in a closed condition;

FIG. 9 shows a three-dimensional view of an example (wall mounted socket) of an electrical power accessory in accordance with the invention;

FIG. 10 shows a three-dimensional view of another example (extension cable socket) of an electrical power accessory in accordance with the invention.

FIG. 11A shows a top three-dimensional view of yet a further example (electrical plug) of an electrical power accessory in accordance with the invention;

FIG. 11B shows a bottom three-dimensional view of the electrical plug of FIG. 11A;

FIG. 11C shows an internal view of the electrical plug of FIG. 11A.

In the drawings, like reference numerals denote like parts of the invention unless otherwise indicated.

### EMBODIMENT OF THE INVENTION

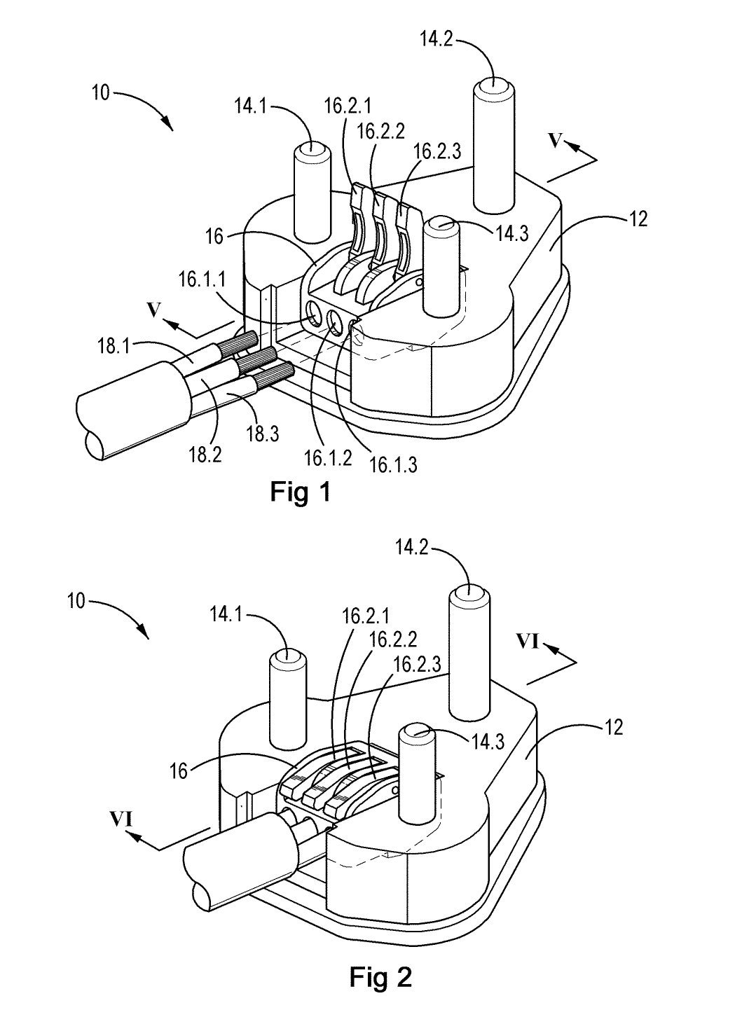

In FIG. 1 reference numeral 10 refers to an electrical plug, which includes a plug housing 12, three male projections 14 extending from a base of the plug housing and a wire connection receptacle 16 integrated into the plug housing 12, accessible from the outside of the housing 12, the wire connection receptacle 16 having three wire receiving formations 16.1.1, 16.1.2, 16.1.3, each wire receiving formation 16.1.1, 16.1.2, 16.1.3 electrically connected to one of the male projections 14.1, 14.2, 14.3.

In this example the three male projections 14.1, 14.2, 14.3 are in the form of prongs. It is to be appreciated that the invention may apply to any type of electrical plug, irrespective of whether the plug includes two or three male projections, and whether the projections are in the form of prongs, blades, pins or the like.

The wire connection receptacle 16 is distant from the male projections. In this example the wire connection receptacle 16 is located at a rear of the plug housing 12.

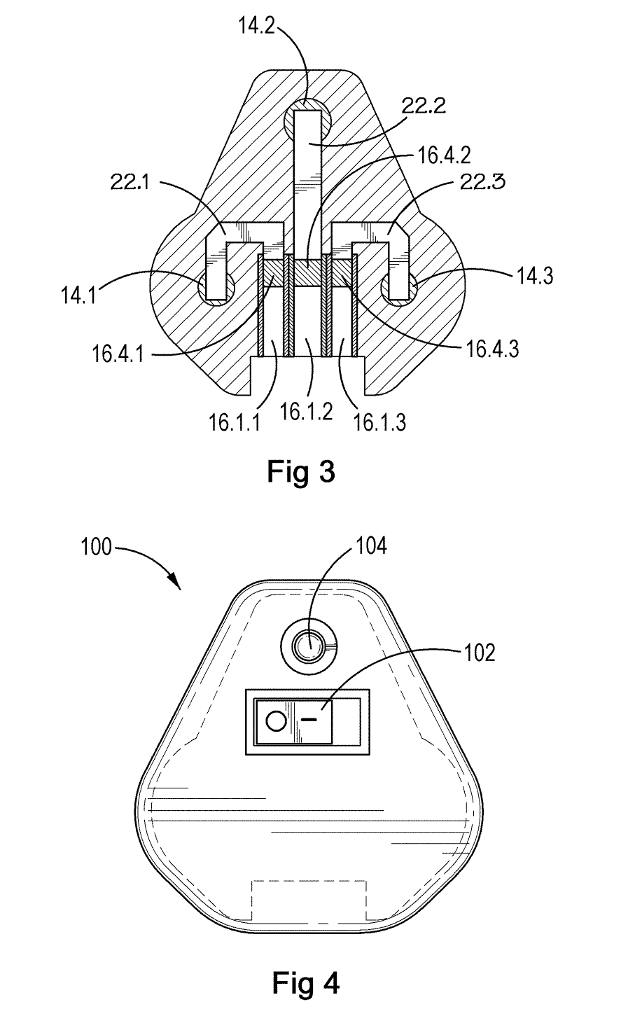

The wire receiving formations 16.1.1, 16.1.2, 16.1.3 are in the form of channels having entrance ports, in use through which a wire is receivable. As shown the entrance ports are located at a rear of the plug housing 12. As shown in FIG. 3 each channel 16.1.1, 16.1.2, 16.1.3 is electrically isolated from the other channels, advantageously preventing a wire received in one wire receiving formation from coming into contact with wires received in the other wire receiving formations. Each channel 16.1.1, 16.1.2, 16.1.3 is shaped and dimensioned to receive only one bared wire from an electrical cable. The cable contains three wires 18.1, 18.2, 18.3 running through a cable sleeve, and each of these wires 18.1, 18.2, 18.3 are receivable in a separate isolated channel 16.1.1, 16.1.2, 16.1.3, respectively.

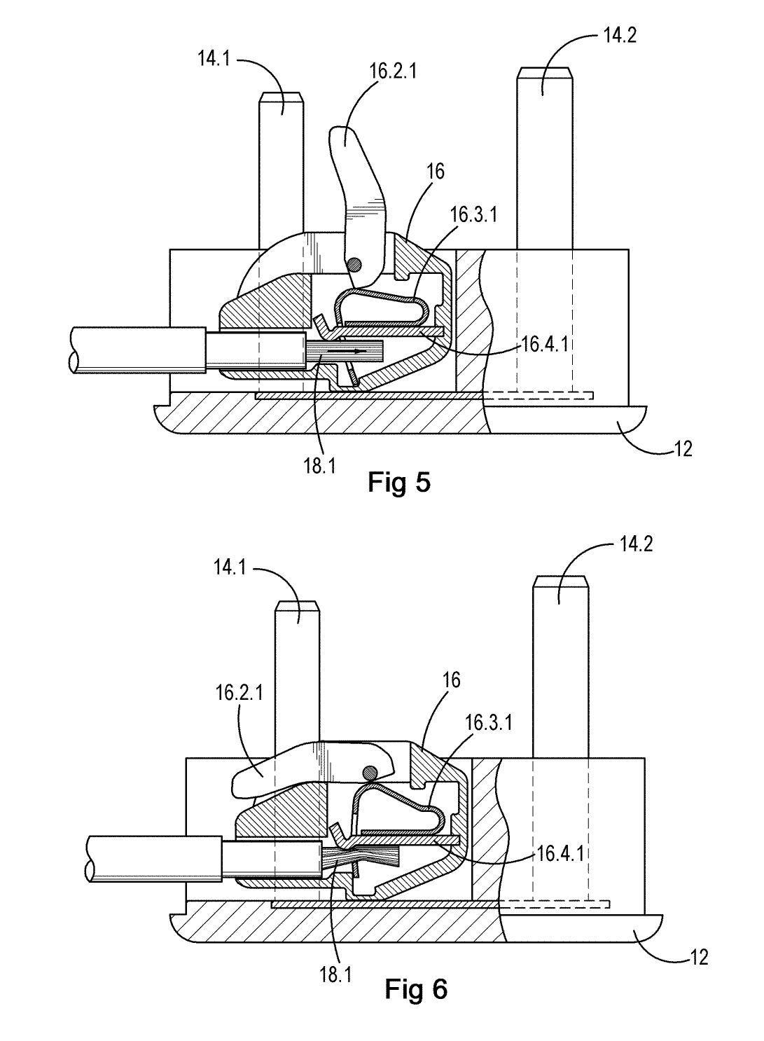

The wire connection receptacle 16 includes wire retainers 16.2.1, 16.2.2, 16.2.3 associated with each of the wire receiving formations 16.1.1, 16.1.2, 16.2.3. The wire retainers 16.2.1, 16.2.2, 16.2.3 are displaceable between an open position (as shown in FIGS. 1 and 5), in which a wire 18.1, 18.2, 18.3 is receivable into the wire receiving formation and a closed position (as shown in FIGS. 2 and 6), in which the wire 18.1, 18.2, 18.3 is retained in the wire receiving formation 16.1.1, 16.1.2, 16.1.3.

In particular, in an open condition, the channels are open and a wire is receivable therein. In a closed position the wire retainers 16.2.1, 16.2.2, 16.2.3 cause a portion of the channel through which a wire 18.1, 18.2, 18.3 is received, to become constricted, in use clamping the wire 18.1, 18.2, 18.3 within the wire connection receptacle 16.1.1, 16.1.2, 16.1.3.

In this embodiment the wire retainers 16.2.1, 16.2.2, 16.2.3 are in the form of levers. Specifically the levers 16.2.1, 16.2.2, 16.2.3 are in the form of cam levers. The cam levers are in the shape of oblong lobes.

Each wire receiving formation 16.1.1, 16.1.2, 16.1.3 further includes a wire confinement, in which a wire is clamped when the wire retainer is in a closed position.

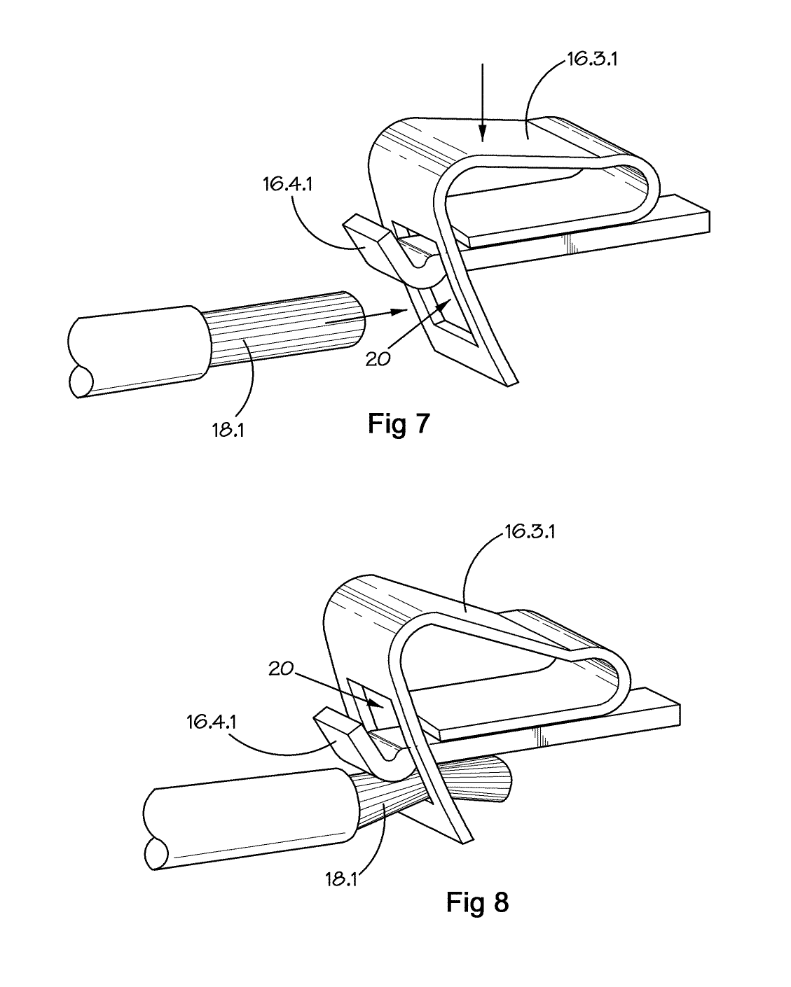

As shown in FIGS. 5 to 8, in this example the wire confinement is in the form of a cage spring 16.3.1, 16.3.2 (not shown), 16.3.3 (not shown). The cage spring 16.3 is in the form of a looped elongate member. A portion of the elongate member defining a framed aperture 20 (as best shown in FIGS. 7 and 8), in line with the channel, such that a wire is received there through.

As shown in FIG. 3, each wire receiving formation 16.1.1, 16.1.2, 16.1.3 is provided with a conductive contact 16.4.1, 16.4.2, 16.4.3. Each conductive contact 16.4.1, 16.4.2, 16.4.3 is electrically connected to a designated male projection 14.1, 14.2, 14.3. In this example the designated male projections 14 are in the form of a neutral 14.1, live 14.3 and protective earth 14.2 connection.

The electrical plug 10 includes indicators (not shown) to identify the type of designated male projection 14.1, 14.2, 14.3 to which the receiving formation 16.1.1, 16.1.2, 16.1.3 is electrically connected. In this example the indicators are in the form of coloured indicators, for example a green and yellow indicator for the receiving formation 16.2.2 connected to the earth connection projection 14.2, a brown indicator for the receiving formation 16.2.3 connected to the live connection 14.3, and a blue indicator for the receiving formation 16.2.1 connected to the neutral connection 14.1.

In this example the conductive contacts 16.4.1, 16.4.2, 16.4.3 are in the form of current bars. The conductive contacts 16.4.1, 16.4.2, 16.4.3 are located inside the wire receiving formations 16.1.1, 16.1.2, 16.1.3, such that a bared wire 18.1, 18.2, 18.3 makes contact with the specific conductive contact 16.4.1, 16.4.2, 16.4.3 when the bared wire 18.1, 18.2, 18.3 is received in the wire receiving formation 16.1.1, 16.1.2, 16.1.3.

As shown in FIG. 3, the electrical connections 22.1, 22.2, 22.3 between the male projections 14.1, 14.2, 14.3 and the respective conductive contacts 16.4.1, 16.4.2, 16.4.3, are in the form of metal connection members, one end welded to the male projections 14.1, 14.2, 14.3 and the opposed end welded to the conductive contact 16.4.1, 16.4.2, 16.4.3. The metal connection members 22.1, 22.2, 22.3 are in the form of copper wire. The metal connection members are in the form of a live connection 22.3, a neutral connection 22.1, and an earth connection 22.2. The electrical connections 22.1, 22.2, 22.3 are omitted in FIGS. 1, 2, 4, 5 and 6 for clarity purposes.

The plug housing 12 is moulded around a portion of the male projections 14 and the wire connection receptacle 16, such that the male projections 14 extend through the plug housing 12 and the wire connection receptacle 16 is accessible from the outside of the housing 12. In this example the plug housing is injection moulded. The plug housing 12 is of unitary construction, advantageously preventing the plug 10 to be opened. In this example the plug housing 12 is of plastic. To manufacture the plug 10, the male projections, electrical connections and wire connection receptacle are inserted into a plug mould in an injection moulding machine and the plug mould is filed with plastic, to provide a solid plug that cannot be opened and has an easily accessible wire connection receptacle 16, for wiring the plug 10.

As best shown in FIGS. 7 and 8 the current bars 16.4 are positioned through the framed aperture 20 of the cage spring 16.3. The cage springs 16.3 are biased upwardly, thereby the lower portion of the frame 20 is pulled upwardly onto the current bar 16.4.

The cam levers 16.2 are movable between an open condition (as shown in FIGS. 1 and 5) and closed condition (as shown in FIGS. 2 and 6). In an open condition the lever 16.2 engages the cage spring 16.3, such as to align the framed aperture 20 with the channel 16.1.

In an open condition (as shown in FIGS. 1 and 5) an upper portion of the lever 16.2 stands proud of the plug housing 12, and a lower portion of the lever 16.2 pushes onto the cage spring 16.3, such that the framed aperture 20 is pushed to a position below the current bar 16.4.1, in line with the channel 16.1, such that a bared wire 18 is receivable through the channel 16.1 and associated framed aperture 20. In an open condition the lever 16.2 is substantially perpendicular to the plug housing 12.

In a closed condition (as shown in FIGS. 2 and 6) the lever 16.2 does not engage the cage spring 16.3, such that the framed aperture returns to an offset position in relation to the channel 16.1. In a closed condition the cam lever 16.2 is received on the plug housing 12, and does not push onto the cage spring 16.3. In use, when a bared wire is received in the receiving formation 16.1, and the lever 16.2 is moved to a closed condition (as shown in FIG. 6 and FIG. 8), the bared wire 18 is clamped between the current bar 16.4 and the framed aperture 20. In a closed condition the lever 16.2 is coplanar to the plug housing 12.

FIG. 4 shows one embodiment of the electrical plug 100. In this example the electrical plug 100 includes an on/off switch 102, connected in circuit between either the live connection or neutral and live connection. The on/off switch 102 is operable to switch the electrical plug 100 on or off without having to switch the wall outlet on or off. The electrical plug 100 also includes an indicator light 104, indicating whether the plug 100 is on or off.

In yet a further embodiment (not shown) the electrical plug may also include a fuse, connected in circuit between either of the live connection or neutral and live connection. The fuse being operable to break the electric current through the electrical plug when the current exceeds a safe, predetermined level.

In use a user may connect the electrical plug to an electrical appliance that requires a replacement plug. The levers 16.2 are lifted to an open position, bared earth, live and neutral wires are inserted into the respective wire receiving formations, and the levers 16.2 are the pushed down to a closed condition. The electrical appliance is then ready to use.

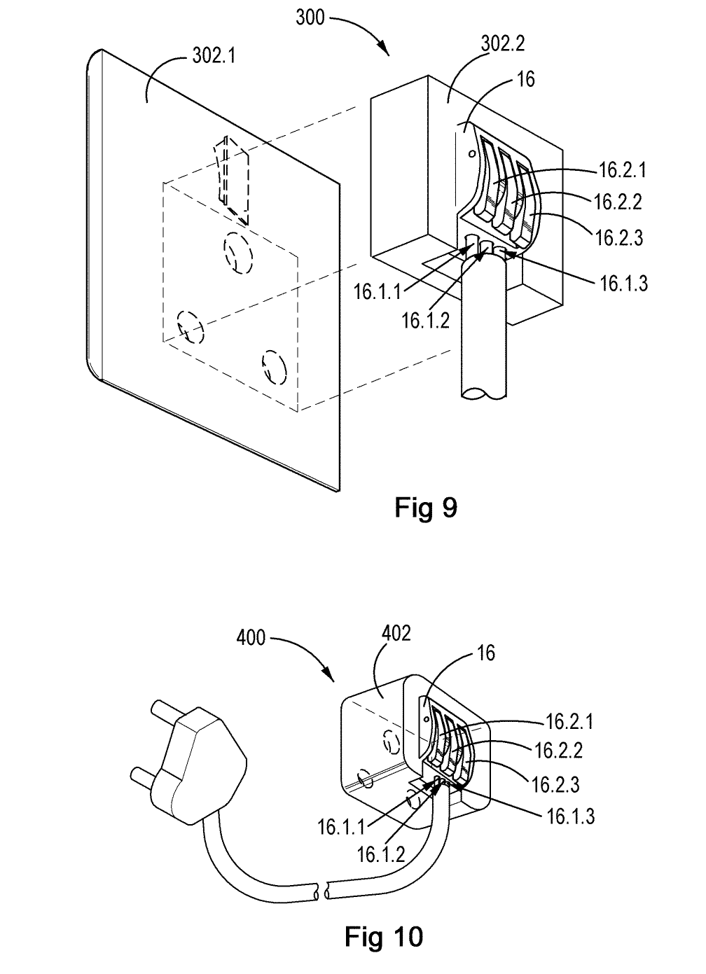

FIG. 9 shows one example of an electrical power accessory 300 in accordance with the invention. In this example the electrical power accessory is in the form of a wall mounted power socket outlet which includes a device housing 302, a wire connection receptacle 16 integrated into the device housing 302, the wire connection receptacle 16 having three wire receiving formations 16.1.1, 16.1.2, 16.1.3 in the form of an earth wire receiving formation, a neutral wire receiving formation and a live wire receiving formation, each wire receiving formation 16.1 having a wire retainer 16.2.1, 16.2.2, 16.2.3 for securing a wire in the receptacle 16, each wire receiving formation 16.1.1, 16.1.2, 16.1.3 being marked according to the type of wire receivable therein. The electrical power accessory 300 further includes an electrical contact (not shown) in each wire receiving formation 16.1.1, 16.1.2, 16.1.3, each electrical contact being connected to an electrical conductor extending from the wire connection receptacle, such that when a wire is received within the wire receiving formation 16.1, the wire is electrically connected to the electrical conductor.

The device housing 302 is in the form of a faceplate 302.1 and mounting box 302.2.

The wire connection receptacle 16 functions the same as explained in detail for the electrical plug above (FIGS. 5, 6, 7 and 8).

In this example the wire retainers 16.2.1, 16.2.2, 16.2.3 are in the form of levers and are coloured (not shown) to match the type of wire receivable therein.

In this example the electrical conductors are in the form of wires (not shown) connecting the three electrical contacts of the three wire receiving formations 16.1.1, 16.1.2, 16.1.3 to the respective terminals, which connects to conductors in the faceplate that ultimately transfer the electricity to a plug plugged into the wall socket.

FIG. 10 shows another example of an electrical power accessory 400 in accordance with the invention. In this example the electrical power accessory is in the form of an extension cable socket box which includes a device housing 402, a wire connection receptacle 16 integrated into the device housing 402, the wire connection receptacle 16 having three wire receiving formations 16.1.1, 16.1.2, 16.1.3 in the form of an earth wire receiving formation, a neutral wire receiving formation and a live wire receiving formation, each wire receiving formation 16.1 having a wire retainer 16.2.1, 16.2.2, 16.2.3 for securing a wire in the receptacle 16, each wire receiving formation 16.1.1, 16.1.2, 16.1.3 being marked according to the type of wire receivable therein. The electrical power accessory 400 further includes an electrical contact (not shown) in each wire receiving formation 16.1.1, 16.1.2, 16.1.3, each electrical contact being connected to an electrical conductor extending from the wire connection receptacle, such that when a wire is received within the wire receiving formation 16.1, the wire is electrically connected to the electrical conductor.

The device housing 402 is in the form of an extension cable socket box.

The wire connection receptacle 16 functions the same as explained in detail for the electrical plug above (FIGS. 5, 6, 7 and 8).

In this example the wire retainers 16.2.1, 16.2.2, 16.2.3 are in the form of levers and are coloured (not shown) to match the type of wire receivable therein.

In this example the electrical conductors are in the form of wires (not shown) connecting the three electrical contacts of the three wire receiving formations 16.1.1, 16.1.2, 16.1.3 to the respective terminals, which connects to conductors in the extension cable socket box that ultimately transfer the electricity to a plug plugged into the extension cable.

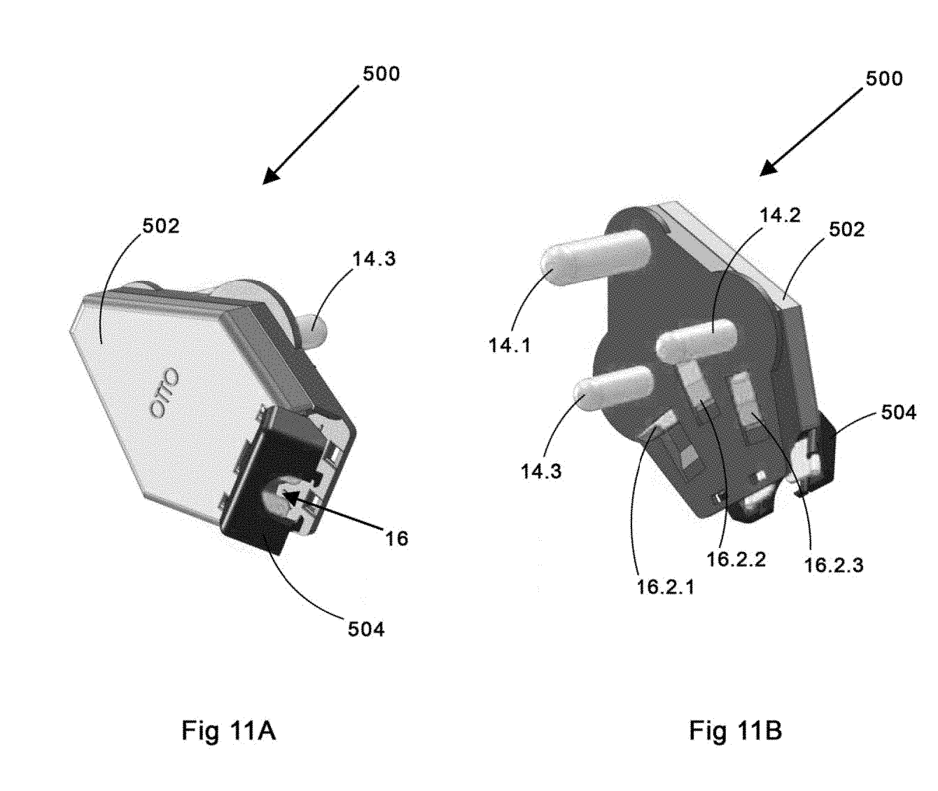

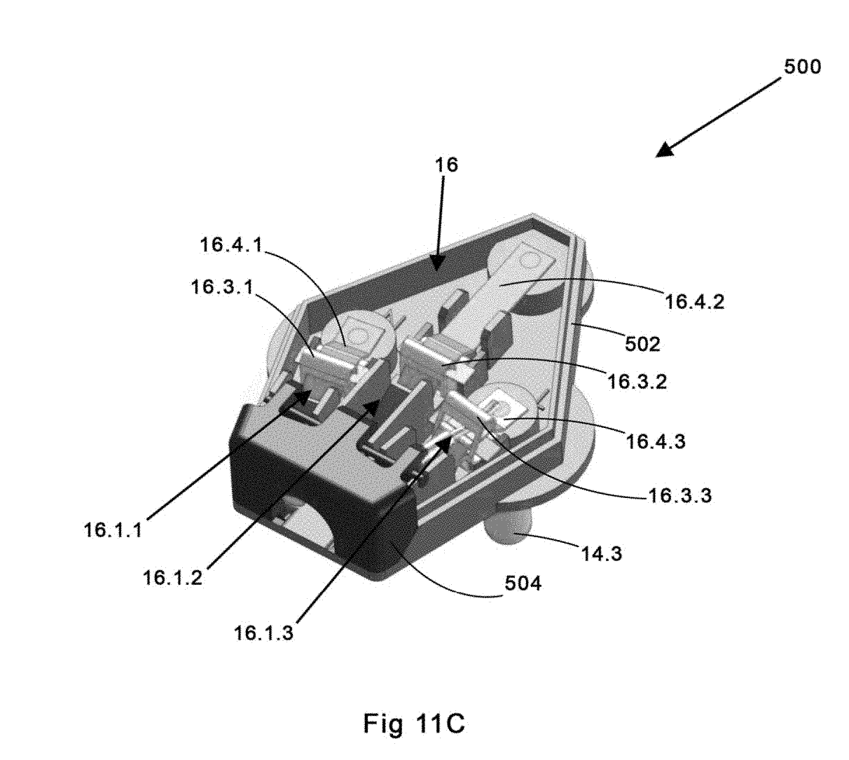

FIG. 11 shows another example of an electrical power accessory 500 in accordance with the invention. In this example the electrical power accessory is in the form of an electrical plug which includes a device housing 502, a wire connection receptacle 16 fully integrated into the device housing 502, the wire connection receptacle 16 having three wire receiving formations 16.1.1, 16.1.2, 16.1.3 in the form of an earth wire receiving formation 16.1.2, a neutral wire receiving formation 16.1.1 and a live wire receiving formation 16.1.3, each wire receiving formation 16.1 having a wire retainer 16.2.1, 16.2.2, 16.2.3 for securing a wire in the receptacle 16, each wire receiving formation being marked according to the type of wire receivable therein. The electrical power accessory 500 further includes an electrical contact 16.4.1, 16.4.2, 16.4.3 in each wire receiving formation 16.1.1, 16.1.2, 16.1.3, each electrical contact being connected to an electrical conductor 14.1, 14.2, 14.3 extending from the wire connection receptacle, such that when a wire is received within the wire receiving formation 16.1, the wire is electrically connected to the electrical conductor.

The device housing 502 is in the form of an electrical plug housing. The wire receiving formations 16.1 define channels, each for receiving a bared wire.

In this example the wire retainers are in the form of levers 16.2.1, 16.2.2, 16.2.3 which presses down or releases wire confinements (in the form of a cage springs) 16.3.1, 16.3.2, 16.3.3. The cage springs are in the form of looped elongate members. A portion of each elongate member defining a framed aperture in line with the wire receiving formations 16.1, such that a wire is received there through. The levers are movable between an open condition and closed condition. In an open condition the levers engages the cage springs 16.3.1, 16.3.2, 16.3.3, such as to align the framed aperture with the wire receiving formations 16.1.

In a closed condition the levers do not engage the cage springs 16.3.1, 16.3.2, 16.3.3 such that the framed aperture returns to an offset position in relation to the wire receiving formations (channels) 16.1. In use, when a bared wire is received in the receiving formation 16.1, and the lever is moved to a closed condition, the bared wire is clamped between the electrical contact 16.4 and the frame of the cage spring 16.3.

In this example the electrical conductors are in the form of male prongs 14.1, 14.2, 14.3 connected to the three electrical contacts 16.4.1, 16.4.2, 16.4.3 of the three wire receiving formations 16.1.1, 16.1.2, 16.1.3.

As shown, the electrical power accessory 500 includes a strain relief clamp 504, for clamping a cable of which the wires are received in the wire connection receptacle 16. The strain relief clamp 504 is in the form of a hinged plug end closure.

The inventor believes that the invention provides a new electrical power accessory, which radically reduces the skill, effort and time required to replace or wire the accessory.

1.-51. (canceled)

52. An electrical power accessory, which includes
a device housing;
a wire connection receptacle integrated into the device housing, the wire connection receptacle having two or more wire receiving formations selected from any two or more of an earth wire receiving formation, a neutral wire receiving formation and a live wire receiving formation, each wire receiving formation having a wire retainer for securing a wire in the receptacle, each wire receiving formation being marked according to the type of wire receivable therein, each wire receiving formation includes a wire confinement in which a wire is clamped when the wire retainer is in a closed position, the wire confinement being in the form of a cage spring defined by a looped elongate member, a portion of the looped elongate member defining a framed aperture through which the wire is receivable; and
an electrical contact in each wire receiving formation, each electrical contact being connected to an electrical conductor extending from the wire connection receptacle, such that when a wire is received within the wire receiving formation, and clamped by the cage spring, the wire is electrically connected to the electrical conductor.

53. The electrical power accessory as claimed in claim 52, in which the electrical power accessory is selected from any one of: an electrical plug, an extension cable socket, wall mounted power socket outlet, wall mounted switches and inline switches.

54. The electrical power accessory as claimed in claim 52, in which the wire receiving formations are in the form of channels having entrance ports, in use through which a wire is receivable into the framed aperture of the cage spring, each channel is electrically isolated from the other channels and is shaped and dimensioned to receive only one bare wire from an electrical cable.

55. The electrical power accessory as claimed in claim 54, in which the wire retainers are displaceable between an open position, in which a wire is receivable into the wire receiving formation and the closed position, in which the wire is retained in the wire receiving formation, in an open position the framed aperture of the cage spring is in line with the channel and a wire is receivable there through, and in a closed position the wire retainer causes the cage spring to move the framed aperture out of alignment with the channel and constrict a wire received therein, in use securing the wire within the wire connection receptacle.

56. The electrical power accessory as claimed in claim 55, in which the wire retainers are in the form of cam levers.

57. The electrical power accessory as claimed in claim 52, which includes indicators associated with the wire receiving formations indicating the type of wire receivable therein, the indicators being in the form of any one or more of: colours, symbols, wording, abbreviations and codes, provided on any one or both of the device housing proximate each wire receiving formation or on the wire retainers.

58. The electrical power accessory as claimed in claim 52, in which the device housing is injection moulded, the device housing being formed around a portion of the wire connection receptacle, such that the wire retainers are accessible from the outside of the housing.

59. The electrical power accessory as claimed in claim 56, in which the electrical contact is in the form of a conducting bar which is positioned through the framed aperture of the cage spring, the cage spring is biased upwardly, thereby in a closed position, the lower portion of the frame is pulled upwardly onto the conducting bar.

60. The electrical power accessory as claimed in claim 59, in which each cam lever is movable between
an open position in which the cam lever is substantially perpendicular to the device housing, an upper portion of the lever stands proud of the device housing, and a lower portion of the lever pushes onto the cage spring, such that the framed aperture is pushed to a position below the conducting bar in line with the channel, such that a bare wire is receivable through the channel and the framed aperture, and
a closed position in which the cam lever is substantially coplanar to the device housing and the cam lever does not push down on the cage spring, such that the framed aperture returns to an offset position in relation to the channel, in use, when a bare wire is received in the receiving formation, and the lever is moved to the closed position, the bare wire is clamped between the conducting bar and the framed aperture.

61. The electrical power accessory as claimed in claim 52, which includes a strain relief clamp, for clamping a cable of which the wires are received in the wire connection receptacle.

62. The electrical power accessory as claimed in claim 52, in which the electrical power accessory is an electrical plug and the device housing is in the form of a plug housing.

63. The electrical power accessory as claimed in claim 62, in which the electrical conductors extending from the plug housing is in the form of male projections in the form of any of prongs, blades and pins, extending from the base of the plug housing, each electrical contact in the wire receiving formations is electrically connected to one of the male projections, the wire connection receptacle is located distant from the male projections, the wire receiving formations are in the form of channels having entrance ports, in use through which a wire is receivable, the entrance ports being located at a rear of the plug housing.

64. The electrical power accessory as claimed in claim 63, in which the electrical connection between the male projections and the respective electrical contacts, is in the form of metal connection members, one end welded to the male projection and the opposed end welded to the electrical contact.

65. The electrical power accessory as claimed in claim 63, in which the plug housing is moulded around a portion of the male projections and wire connection receptacle, such that the male projections extend through the plug housing and the wire retainers are accessible from the outside of the housing.

66. The electrical power accessory as claimed in claim 62, in which the electrical plug further includes an on/off switch, connected in circuit between either the live wire receiving formation or neutral and live wire receiving formation, the on/off switch operable to switch the electrical plug off/on without having to switch a wall outlet on/off.

67. The electrical power accessory as claimed in claim 62, in which the electrical plug further includes an on/off indicator, in the form of an indication light, operable to indicate whether the electrical plug is off or on.

68. The electrical power accessory as claimed in claim 62, in which the electrical plug further includes a fuse, connected in circuit between either of the live wire receiving formation or neutral and live wire receiving formation, the fuse being operable to break electric current through the electrical plug when the current exceeds a safe, predetermined level.

69. The electrical power accessory as claimed in claim 62, in which the plug housing includes a hingeable strain relief clamp, for clamping a cable connected to the electrical plug, the strain relief clamp being located at a rear of the plug, in front of the wire receiving formations.

70. The electrical power accessory as claimed in claim 52, in which the electrical power accessory is in the form of a wall mounted power socket outlet, and the device housing is in the form of a mounting box over which a wall faceplate is secured, for connecting the socket outlet to respective electrical terminals of the building.
